(19) United States
(12) Patent Application Publication
(10) Pub. No.: US 2025/0079715 A1
(43) Pub. Date: Mar. 6, 2025

(54) Electronic Device with Waveguided Short Range Antennas

(71) Applicant: Apple Inc., Cupertino, CA (US)

(72) Inventors: Xiaofang Mu, San Jose, CA (US); Bernd W Adler, San Jose, CA (US); Jorge L Rivera Espinoza, Los Gatos, CA (US); Grant S Haug, San Francisco, CA (US)

(21) Appl. No.: 18/810,228

(22) Filed: Aug. 20, 2024

Related U.S. Application Data
(60) Provisional application No. 63/579,839, filed on Aug. 31, 2023.

(51) Int. Cl. H01Q 13/02; H01Q 13/06

(52) U.S. Cl. CPC H01Q 13/02; H01Q 13/06

(57) ABSTRACT

A communications system may include a first electronic device and a second electronic device that communicate over a high speed short range wireless communications link. To support the link, each device includes one or more antennas that concurrently transmit(s) and receive(s) radio-frequency signals at the same frequency under an in-band full duplex (IBFD) scheme. One device may include a housing wall and a waveguide. The waveguide has an elongated portion facing the antenna(s) and a horn extending from the elongated portion. The waveguide may convey the radio-frequency signals between the antenna(s) and the other device through the wall. The waveguide may serve to mitigate signal leakage from a transmit port onto a receive port of the device while conveying wireless data over the high speed short range wireless communications link. In addition, the waveguide allows flexibility in configuring the antennas and enhances system robustness with larger alignment tolerances.

This application claims the benefit of U.S. Provisional Patent Application No. 63/579,839, filed Aug. 31, 2023, which is hereby incorporated by reference herein in its entirety.

### FIELD

This disclosure relates generally to electronic devices, including electronic devices with wireless communications circuitry.

### BACKGROUND

Electronic devices often include wireless communications circuitry. For example, cellular telephones, computers, and other devices often contain antennas and wireless transceivers for supporting wireless communications.

Some electronic devices include antennas having a transmit port that transmits signals and a receive port that receives signals. If care is not taken, signal leakage from the transmit port onto the receive port can deteriorate wireless performance of the electronic device.

### SUMMARY

A communications system may include a first electronic device and a second electronic device that communicate over a high speed short range wireless communications link. To support the link, each device includes one or more antennas that concurrently transmit(s) and receive(s) radio-frequency signals at the same frequency under an in-band full duplex (IBFD) scheme. The frequency may be between around 57 GHz and 64 GHz, for example.

One of the devices may include a housing wall and a waveguide disposed between the antenna(s) and the housing wall. The waveguide has an elongated portion facing the antenna(s) and a horn extending from the elongated portion and facing the wall. The waveguide may convey the radio-frequency signals between the antenna(s) and the other device through the wall. The horn and the elongated portion may extend along the same longitudinal axis or along different non-parallel longitudinal axes. Some but not all of the horn may be covered with conductive material. The waveguide may serve to mitigate signal leakage from a transmit port onto a receive port of the device while conveying wireless data over the high speed short range wireless communications link.

An aspect of the disclosure provides an electronic device. The electronic device can include a housing wall. The electronic device can include one or more antennas having a transmit port and a receive port. The electronic device can include a waveguide between the housing wall and the one or more antennas. The transmit port and the receive port can be configured to concurrently convey, through the waveguide and the housing wall, first and second streams of wireless data under an in-band full duplex scheme.

An aspect of the disclosure provides an electronic device. The electronic device can include an antenna. The electronic device can include a housing having a wall. The electronic device can include a waveguide extending from a first surface facing the antenna to an opposing second surface facing the wall. The first surface can have a first width. The second surface can have a second width greater than the first width. The antenna can be configured to concurrently transmit and receive radio-frequency signals at a frequency through the waveguide and the wall.

An aspect of the disclosure provides an electronic device configured to dock a first device to a second device. The electronic device can include a transmit antenna configured to transmit first radio-frequency signals at a frequency. The electronic device can include a receive antenna configured to receive second radio-frequency signals at the frequency concurrent with transmission of the first radio-frequency signals by the transmit antenna. The electronic device can include a housing wall. The electronic device can include a waveguide extending from a first end having a first width to an opposing second end having a second width greater than the first width, wherein the first end faces and overlaps the transmit antenna and the receive antenna, the waveguide has a first portion that extends from the first end, the first portion having the first width, the waveguide has a second portion that extends from the first portion to the second end, the second portion having a width that increases from the first width at the first portion to the second width at the second end, the waveguide is configured to convey the first radio-frequency signals from the transmit antenna through the housing wall, and the waveguide is configured to convey the second radio-frequency signals from the housing wall to the receive antenna.

### BRIEF DESCRIPTION OF THE DRAWINGS

FIG. 1 is a diagram of an illustrative communications system having first and second electronic devices that communicate using a short range wireless communications link in accordance with some embodiments.

FIG. 2 is a perspective view of an illustrative communications system in which a portable electronic device and a dock device communicate using a short range wireless communications link in accordance with some embodiments.

FIG. 3 is a cross-sectional side view of an illustrative electronic device having an antenna mounted against a housing wall for supporting a short range wireless communications link in accordance with some embodiments.

FIG. 4 is a schematic side view showing how first and second electronic devices may each include a single antenna for performing in-band full duplex communications over a short range wireless communications link in accordance with some embodiments.

FIG. 5 is a schematic side view showing how first and second electronic devices may each include transmit and receive antennas for performing in-band full duplex communications over a short range wireless communications link in accordance with some embodiments.

FIG. 6 is a cross-sectional side view of an illustrative electronic device having a waveguide overlapping antenna(s) that perform in-band full duplex communications over a short range wireless communications link in accordance with some embodiments.

FIG. 7 is a cross-sectional side view of an illustrative waveguide having an elongated portion and a horn portion that extend along non-parallel longitudinal axes in accordance with some embodiments.

FIG. 8 is a cross-sectional side view of an illustrative waveguide having a horn portion that faces towards overlapping antenna(s) in accordance with some embodiments.

FIG. 9 is a cross-sectional side view of an illustrative waveguide having a horn portion that faces towards overlapping antenna(s) and having an elongated portion that extends away from the horn portion along a non-parallel longitudinal axis in accordance with some embodiments.

FIG. 10 is a cross-sectional side view of an illustrative waveguide having first and second horn portions on opposing sides of an elongated portion in accordance with some embodiments.

FIG. 11 is a cross-sectional side view of an illustrative waveguide having first and second horn portions on opposing sides of an elongated portion that extends along a non-parallel longitudinal axis in accordance with some embodiments.

FIG. 12 is a cross-sectional top view showing how an illustrative waveguide may overlap underlying antenna(s) on an external device in accordance with some embodiments.

FIG. 13 is a cross-sectional top view of an illustrative waveguide having a rectangular cross section in accordance with some embodiments.

### DETAILED DESCRIPTION

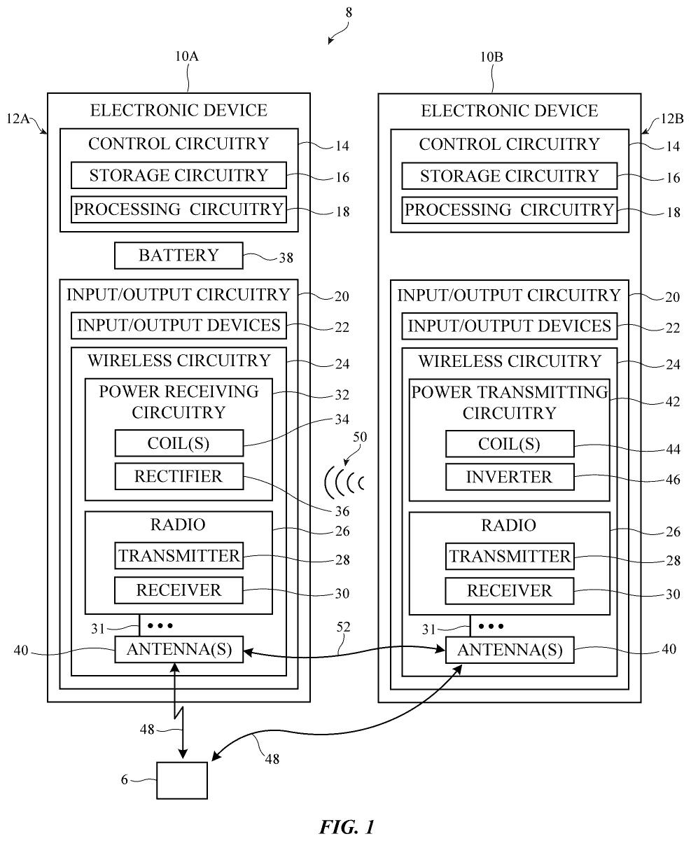

FIG. 1 is a diagram of an illustrative communications system 8. Communications system 8 (sometimes referred to herein as communications network 8, network 8, or system 8) may include one or more electronic devices 10 such as at least a first device 10A and a second device 10B (e.g., user equipment (UE) devices).

In general, communications system 8 may include any desired number of network nodes, terminals, and/or end hosts that are communicably coupled together using communications paths that include wired and/or wireless links. The wired links may include cables (e.g., ethernet cables, optical fibers or other optical cables that convey signals using light, telephone cables, radio-frequency cables such as coaxial cables or other transmission lines, etc.). The wireless links may include short range wireless communications links that operate over a range of inches, feet, or tens of feet, medium range wireless communications links that operate over a range of hundreds of feet, thousands of feet, miles, or tens of miles, and/or long range wireless communications links that operate over a range of hundreds or thousands of miles.

The nodes of communications system 8 may be organized into one or more relay networks, mesh networks, local area networks (LANs), wireless local area networks (WLANs), ring networks (e.g., optical rings), cloud networks, virtual/logical networks, the Internet (e.g., may be communicably coupled to each other over the Internet), combinations of these, and/or using any other desired network topologies. The network nodes, terminals, and/or end hosts of communications system 8 may include network switches, network routers, optical add-drop multiplexers, other multiplexers, repeaters, modems, portals, gateways, servers, network cards (line cards), wireless access points, wireless base stations, and/or any other desired network components. Devices 10A and 10B may form respective network nodes of communications system 8.

Devices 10A and 10B may be portable electronic devices or other suitable electronic devices. For example, device 10A and/or device 10B may each be a laptop computer, a tablet computer, a somewhat smaller device such as a wrist-watch device, pendant device, headphone device, earpiece device, headset device, head-mounted display device (e.g., virtual and/or augmented reality glasses or goggles), or another wearable or miniature device, a handheld device such as a cellular telephone, a media player, or other small portable device, a set-top box, a desktop computer, a media player, a display into which a computer or other processing circuitry has been integrated, a display without an integrated computer, a dock device (e.g., for docking a portable device such as a cellular telephone to a display without an integrated computer), a wireless access point, a wireless base station, an electronic device incorporated into a kiosk, building, or vehicle, or other suitable electronic equipment. Devices 10A and 10B need not be the same type of device.

Device 10A may include a housing such as housing 12A. Device 10B may include a housing such as housing 12B. Housings 12A and 12B, which are sometimes also referred to as cases, may each be formed from plastic, glass, ceramics, fiber composites, metal (e.g., stainless steel, aluminum, titanium, etc.), other suitable materials, or a combination of these materials. In some situations, parts of housings 12A and/or 12B may be formed from dielectric or other low-conductivity material (e.g., glass, ceramic, plastic, sapphire, etc.). In other situations, housings 12A and/or 12B or at least some of the structures that make up housings 12A and/or 12B may be formed from metal elements.

Device 10A and device 10B may each include control circuitry such as control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc.

Control circuitry 14 may include processing circuitry such as processing circuitry 18. Processing circuitry 18 may be used to control the operation of devices 10A and 10B. Processing circuitry 18 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in devices 10A and 10B using hardware (e.g., dedicated hardware or circuitry), firmware, and/or software. Software code for performing operations in devices 10A and 10B may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on devices 10A and 10B such as internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network protocols (e.g., IEEE 802.11 protocols-sometimes referred to as WiFi®), protocols for other wireless communications links such as the Bluetooth® protocol or other WPAN protocols, IEEE 802.11ad protocols, cellular telephone protocols, MIMO protocols, antenna diversity protocols, satellite navigation system protocols, antenna-based spatial ranging protocols (e.g., radio detection and ranging (RADAR) protocols or other desired range detection protocols for signals conveyed at millimeter and centimeter wave frequencies), wireless charging (power transfer) protocols, short range communications link protocols (e.g., wireless data transfer protocols that support in-band full duplex communications), etc. Each communication protocol may be associated with a corresponding radio access technology (RAT) that specifies the physical connection methodology used in implementing the protocol.

Devices 10A and 10B may each include input-output circuitry such as input-output circuitry 20. Input-output circuitry 20 may include input-output devices 22. Input-output devices 22 may be used to allow data to be supplied to devices 10A and 10B and to allow data to be provided from devices 10A and 10B to external devices. Input-output devices 22 may include user interface devices, data port devices, sensors, and other input-output components. For example, input-output devices 22 may include displays (e.g., touch screens, displays without touch sensor capabilities, etc.), buttons, joysticks, scrolling wheels, touch pads, key pads, keyboards, microphones, cameras, speakers, status indicators, light sources, audio jacks and other audio port components, digital data port devices, light sensors, gyroscopes, accelerometers or other components that can detect motion and device orientation relative to the Earth, capacitance sensors, proximity sensors (e.g., a capacitive proximity sensor and/or an infrared proximity sensor), magnetic sensors, and other sensors and input-output components.

Input-output circuitry 20 may include wireless circuitry 24 that supports wireless communications. Wireless circuitry 24 (sometimes referred to herein as wireless communications circuitry 24) may include one or more antennas 40. Wireless circuitry 24 may also include one or more radios 26. Radio 26 may include circuitry that operates on signals at baseband frequencies (e.g., baseband circuitry) and radio-frequency transceiver circuitry such as one or more radio-frequency transmitters 28 and one or more radio-frequency receivers 30. Transmitter 28 may include signal generator circuitry, modulation circuitry, mixer circuitry for upconverting signals from baseband frequencies to intermediate frequencies and/or radio frequencies, amplifier circuitry such as one or more power amplifiers, digital-to-analog converter (DAC) circuitry, control paths, power supply paths, switching circuitry, filter circuitry, and/or any other circuitry for transmitting radio-frequency signals using antenna(s) 40. Receiver 30 may include demodulation circuitry, mixer circuitry for downconverting signals from intermediate frequencies and/or radio frequencies to baseband frequencies, amplifier circuitry (e.g., one or more low-noise amplifiers (LNAs)), analog-to-digital converter (ADC) circuitry, control paths, power supply paths, signal paths, switching circuitry, filter circuitry, and/or any other circuitry for receiving radio-frequency signals using antenna(s) 40. The components of radio 26 may be mounted onto a single substrate or integrated into a single integrated circuit, chip, package, or system-on-chip (SOC) or may be distributed between multiple substrates, integrated circuits, chips, packages, or SOCs.

The antenna(s) 40 on devices 10A and 10B may be formed using any desired antenna structures for conveying radio-frequency signals. For example, antenna(s) 40 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. Filter circuitry, switching circuitry, impedance matching circuitry, and/or other antenna tuning components may be adjusted to adjust the frequency response and wireless performance of antenna(s) 40 over time. If desired, two or more of antennas 40 may be integrated into a phased antenna array (sometimes referred to herein as a phased array antenna) in which each of the antennas conveys radio-frequency signals with a respective phase and magnitude that is adjusted over time so the radio-frequency signals constructively and destructively interfere to produce a signal beam in a given/selected beam pointing direction.

The term “convey radio-frequency signals” as used herein means the transmission and/or reception of the radio-frequency signals (e.g., for performing unidirectional and/or bidirectional wireless communications with external wireless communications equipment). Similarly, the term “convey wireless data” as used herein means the transmission and/or reception of wireless data using radio-frequency signals. Antenna(s) 40 may transmit the radio-frequency signals by radiating the radio-frequency signals into free space (or to free space through intervening device structures such as a dielectric cover layer). Antenna(s) 40 may additionally or alternatively receive the radio-frequency signals from free space (e.g., through intervening devices structures such as a dielectric cover layer). The transmission and reception of radio-frequency signals by antennas 40 each involve the excitation or resonance of antenna currents on an antenna resonating element in the antenna by the radio-frequency signals within the frequency band(s) of operation of the antenna.

Each radio 26 may be coupled to one or more antennas 40 over one or more radio-frequency transmission lines 31. Radio-frequency transmission lines 31 may include coaxial cables, microstrip transmission lines, stripline transmission lines, edge-coupled microstrip transmission lines, edge-coupled stripline transmission lines, transmission lines formed from combinations of transmission lines of these types, etc. Radio-frequency transmission lines 31 may be integrated into rigid and/or flexible printed circuit boards if desired. One or more radio-frequency lines 31 may be shared between multiple radios 26 if desired. Radio-frequency front end (RFFE) modules may be interposed on one or more radio-frequency transmission lines 31. The radio-frequency front end modules may include substrates, integrated circuits, chips, or packages that are separate from radios 26 and may include filter circuitry, switching circuitry, amplifier circuitry, impedance matching circuitry, radio-frequency coupler circuitry, and/or any other desired radio-frequency circuitry for operating on the radio-frequency signals conveyed over radio-frequency transmission lines 31.

Radio 26 may transmit and/or receive radio-frequency signals within corresponding frequency bands at radio frequencies (sometimes referred to herein as communications bands or simply as “bands”). The frequency bands handled by radio 26 may include wireless local area network (WLAN) frequency bands (e.g., Wi-Fi® (IEEE 802.11) or other WLAN communications bands) such as a 2.4 GHz WLAN band (e.g., from 2400 to 2480 MHZ), a 5 GHZ WLAN band (e.g., from 5180 to 5825 MHZ), a Wi-Fi® 6E band (e.g., from 5925-7125 MHZ), and/or other Wi-Fi® bands (e.g., from 1875-5160 MHZ), wireless personal area network (WPAN) frequency bands such as the 2.4 GHz Bluetooth® band or other WPAN communications bands, cellular telephone frequency bands (e.g., bands from about 600 MHz to about 5 GHZ, 3G bands, 4G LTE bands, 5G New Radio Frequency Range 1 (FR1) bands below 10 GHz, 5G New Radio Frequency Range 2 (FR2) bands between 20 and 60 GHz, cellular sidebands, 6G bands between 100-1000 GHz (e.g., sub-THz, THz, or THF bands), etc.), other centimeter or millimeter wave frequency bands between 10-300 GHz (e.g., a short range wireless data transfer band that supports in-band full duplex communications such as a band between around 57 GHz and 64 GHZ), near-field communications frequency bands (e.g., at 13.56 MHZ), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, industrial, scientific, and medical (ISM) bands such as an ISM band between around 900 MHz and 950 MHz or other ISM bands below or above 1 GHZ, one or more unlicensed bands, one or more bands reserved for emergency and/or public services, and/or any other desired frequency bands of interest. Wireless circuitry 24 may also be used to perform spatial ranging operations if desired.

The example of FIG. 1 is illustrative and non-limiting. While control circuitry 14 is shown separately from wireless circuitry 24 in the example of FIG. 1 for the sake of clarity, wireless circuitry 24 may include processing circuitry (e.g., one or more processors) that forms a part of processing circuitry 18 and/or storage circuitry that forms a part of storage circuitry 16 of control circuitry 14 (e.g., portions of control circuitry 14 may be implemented on wireless circuitry 24). As an example, control circuitry 14 may include baseband circuitry (e.g., one or more baseband processors), digital control circuitry, analog control circuitry, and/or other control circuitry that forms part of radio 26. The baseband circuitry may, for example, access a communication protocol stack on control circuitry 14 (e.g., storage circuitry 16) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum (NAS) layer. If desired, the PHY layer operations may additionally or alternatively be performed by radio-frequency (RF) interface circuitry in wireless circuitry 24.

When device 10B is brought into close proximity to device 10A (e.g., within a few mm or cm), device 10A and device 10B may exchange wireless data over short range wireless communications link 52. Antennas 40 on devices 10A and 10B may convey radio-frequency signals to support short range wireless communications link 52. In practice, it may be desirable for device 10A and device 10B to be able to exchange wireless data between each other over short range wireless communications link 52 at as high a speed (data rate) as possible.

For example, when device 10B is in close proximity to device 10A, it may be desirable to exchange wireless data between devices 10A and 10B at a data rate similar to as if a wired communication link (e.g., a Universal Serial Bus Type-C(USB-C) cable or another type of data transfer cable) were connected between devices 10A and 10B. Short range wireless communications link 52 may therefore be configured to exhibit a similar data rate to a high speed wired communication link (e.g., at least 5-10 Gbps). In this way, short range wireless communications link 52 may convey wireless data between devices 10A and 10B as if a wired communication link were present between devices 10A and 10B, but without requiring a user to possess a data transfer cable or to physically connect such a cable between devices 10A and 10B. In other words, short range wireless communications link 52 and the corresponding antenna(s) 40 on devices 10A and 10B may effectively form a high speed wireless data connector between devices 10A and 10B.

To help maximize the data rate of short range wireless communications link 52, the radio-frequency signals of short range wireless communications link 52 may be conveyed at relatively high frequencies such as millimeter wave frequencies. As one example, the radio-frequency signals may be conveyed in a short range wireless data transfer band between around 57 GHz and 64 GHz. However, increasing the frequency of short range wireless communications link 52 may be insufficient on its own to configure short range wireless communications link 52 to meet the high data rates of modern data transfer cables (e.g., 5-10 Gbps or higher). To further boost the data rate of short range wireless communications link 52, short range wireless communications link 52 may implement an in-band full duplex (IBFD) communications scheme.

Under IBFD, device 10A transmits a first stream of wireless data to device 10B and simultaneously receives a second stream of wireless data from device 10B at the same frequencies (e.g., frequencies in the band between around 57 GHz and 64 GHz). Performing full duplexing (e.g., simultaneously conveying streams of wireless data in both directions between devices 10A and 10B) effectively doubles the data rate of short range wireless communications link 52 relative to implementations where device 10A only transmits or only receives wireless data at a single time.

Performing the full duplexing in-band, where both the first and second streams of wireless data are conveyed by radio-frequency signals at the same frequencies, serves to minimize power consumption on devices 10A and 10B. For example, in implementations where the 57-64 GHz band is divided into a first sub-band at a first subset of frequencies from 57-64 GHz (e.g., 57-60.5 GHz) for conveying the first stream of wireless data from device 10A to device 10B and a second sub-band at a second subset of frequencies from 57-64 GHz (e.g., 60.5-64 GHz) for conveying the second stream of wireless data from device 10B to device 10A, a higher order modulation scheme (e.g., a high order quadrature amplitude modulation (QAM) scheme) may be required for the wireless data to achieve the same data rates as in-band full duplexing. However, higher order modulation schemes require more power to encode and decode wireless data than lower order modulation schemes. In-band full duplexing may, for example, allow the wireless data to be conveyed over short range wireless communications link 52 using a relatively low order modulation scheme (e.g., frequency shift keying (FSK), amplitude shift keying (ASK), etc.) that consumes much less power than higher order modulation schemes.

If desired, one or more of antennas 40 on device 10A and/or device 10B may convey radio-frequency signals 48 (e.g., additional streams of wireless data) with other external equipment such as external device 6. External device 6 may be a wireless base station, a wireless access point, a communications satellite, another device 10, or a peripheral or accessory device (e.g., a wireless computer stylus, mouse, track pad, keyboard, etc.), as examples. Devices 10A and/or 10B may use different antennas 40 to convey radio-frequency signals 48 and to support short range wireless communications link 52. Alternatively, one or more of the same antennas 40 on device 10A and/or device 10B may convey both radio-frequency signals 48 and radio-frequency signals for short range wireless communications link 52.

Radio-frequency signals 48 may be used to support one or more long range communications links between device 10A and external device 6 and/or between device 10B and external device 6. The long range communications link(s) involve greater distances than short range wireless communications link 52 and can extend from a few inches to hundreds of miles, for example. Radio-frequency signals 48 may be conveyed using cellular telephone bands, wireless local area network bands, wireless personal area network bands, satellite communications bands, satellite navigation bands, device-to-device (D2D) bands, or other bands. Short range wireless communications link 52 may, for example, support higher data rates than radio-frequency signals 48.

If desired, when device 10A is in close proximity to device 10B (e.g., close enough to convey wireless data over short range wireless communications link 52), device 10B may transmit wireless power to device 10A. Device 10B may, for example, be a wireless power transmitting device or a device having wireless power transmission capabilities. On the other hand, device 10A may be a wireless power receiving device or a device having wireless power reception capabilities.

To support wireless power transmission, device 10B may be connected to a wall outlet, may be coupled to a wall outlet via an external power adapter or another device, may have a battery for supplying power, and/or may be connected to another device that provides power to device 10B. Device 10B may include power transmitting circuitry 42. Power transmitting circuitry 42 may have switching circuitry, such as inverter circuitry 46 formed from transistors, that are turned on and off based on control signals provided by control circuitry 14 to create AC current signals through one or more wireless power transmitting coils such as wireless power transmitting coil(s) 44. These coil drive signals cause coil(s) 44 to transmit wireless power (e.g., as wireless power signals 50, sometimes also referred to herein as wireless charging signals 50 or simply as wireless power 50). In implementations where coil(s) 44 include multiple coils, the coils may be disposed on a ferromagnetic structure, arranged in a planar coil array, or may be arranged to form a cluster of coils (e.g., two or more coils, 5-10 coils, at least 10 coils, 10-30 coils, fewer than 35 coils, fewer than 25 coils, or other suitable number of coils). In some implementations, device 10B includes only a single coil 44.

As the AC currents pass through one or more coils 44, alternating-current electromagnetic (e.g., magnetic) fields (wireless power signals 50) are produced that are received by one or more corresponding receiver coils such as coil(s) 34 in power receiving circuitry 32 on device 10A. In other words, one or more of coils 44 is inductively coupled to one or more of coils 34. Device 10A may have a single coil 34, at least two coils 34, at least three coils 34, at least four coils 34, or another suitable number of coils 34. When the alternating-current electromagnetic fields are received by coil(s) 34, corresponding alternating-current currents are induced in coil(s) 34. The AC signals that are used in transmitting wireless power may have any suitable frequency (e.g., 100-400 kHz, 1-100 MHz, etc.). Rectifier circuitry such as rectifier circuitry 36, which contains rectifying components such as synchronous rectification transistors arranged in a bridge network, converts received AC signals (received alternating-current signals associated with wireless power signals 50) from one or more coils 34 into DC voltage signals for powering device 10A and/or for charging a battery 38 on device 10A.

The example of FIG. 1 is illustrative and non-limiting. Device 10A and/or device 10B need not convey radio-frequency signals 48 with external device 6. Device 10B need not transmit wireless power signals 50 to device 10A. If desired, device 10A may be a wireless power transmitting device (e.g., may include power transmitting circuitry 42) whereas device 10B is a wireless power receiving device (e.g., may include power receiving circuitry 32). If desired, device 10A and/or device 10B may be both a wireless power transmitting device and a wireless power receiving device (e.g., device 10A and/or device 10B may include both power receiving circuitry 32 and power transmitting circuitry 42).

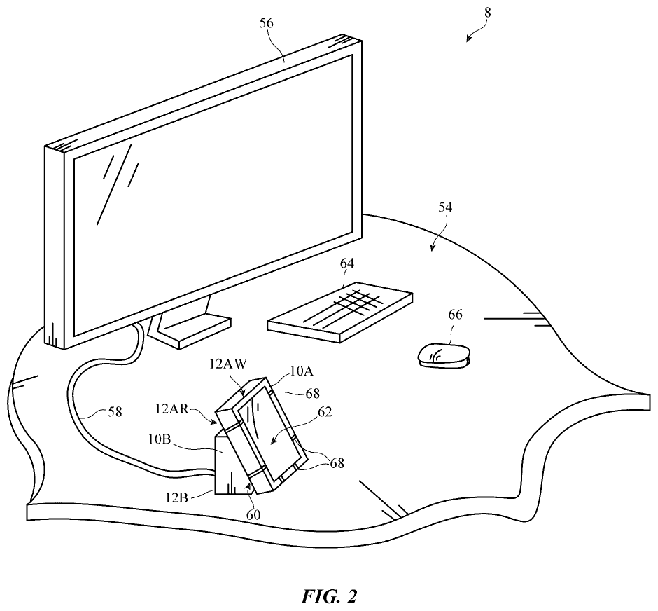

FIG. 2 is a perspective view of one illustrative system 8 in which device 10A is a portable electronic device (e.g., a cellular telephone, a tablet computer, a wristwatch, a head mounted display device, etc.) and in which device 10B is a dock device. As shown in FIG. 2, system 8 may also include one or more external devices such as external devices 56, 64, and 66. External device 56 may be, for example, a computer monitor or display (e.g., a display without an integrated computer) and is therefore sometimes referred to herein as monitor 56. External devices 64 and 66 may be accessory or peripheral devices (e.g., user input devices) such as a wireless keyboard and a wireless mouse, respectively.

Monitor 56 and device 10B may be placed on an underlying surface such as surface 54 (e.g., a tabletop, desktop, etc.). Device 10B may communicate with monitor 56 over a wired communications link such as data transfer cable 58. Data transfer cable 58 may be coupled to a data input/output port of monitor 56 and may be coupled to a data input/output port of device 10B. Data transfer cable 58 may convey data (e.g., video data, image data, audio data, etc.) from device 10B to monitor 56. A display on monitor 56 may display the data. If desired, other output components of monitor 56 may output other data received from device 10B over data transfer cable 58. If desired, data transfer cable 58 may convey power from monitor 56 to device 10B.

In the example of FIG. 2, device 10B is a dock device that serves as a continuity dock between device 10A and monitor 56. Device 10B may, for example, have no display. On the other hand, device 10A may have a display such as display 62. Display 62 may be mounted on the front face of device 10A. Display 62 may be a touch screen that incorporates capacitive touch electrodes or may be insensitive to touch. The rear face of the housing 12A of device 10A (e.g., the face of device 10A opposing the front face of device 10A) may have a substantially planar housing wall such as rear housing wall 12AR (e.g., a planar housing wall). Rear housing wall 12AR may have slots that pass entirely through the rear housing wall and that therefore separate portions of housing 12A from each other. Rear housing wall 12AR may include conductive portions and/or dielectric portions. If desired, rear housing wall 12AR may include a planar metal layer covered by a thin layer or coating of dielectric such as glass, plastic, sapphire, or ceramic (e.g., a dielectric cover layer). Housing 12A may also have shallow grooves that do not pass entirely through housing 12A. The slots and grooves may be filled with plastic or other dielectric materials. If desired, portions of housing 12A that have been separated from each other (e.g., by a through slot) may be joined by internal conductive structures (e.g., sheet metal or other metal members that bridge the slot).

Housing 12A may include peripheral housing structures such as peripheral structures 12AW. Conductive portions of peripheral structures 12AW and conductive portions of rear housing wall 12AR may sometimes be referred to herein collectively as conductive structures of housing 12A. Peripheral structures 12AW may run around the periphery of device 10A and display 62. In configurations in which device 10A and display 62 have a rectangular shape with four edges, peripheral structures 12AW may be implemented using peripheral housing structures that have a rectangular ring shape with four corresponding edges and that extend from rear housing wall 12AR to the front face of device 10A (as an example). In other words, device 10A may have a length, a width that is less than the length, and a height that is less than the width. Peripheral structures 12AW or part of peripheral structures 12AW may serve as a bezel for display 62 (e.g., a cosmetic trim that surrounds all four sides of display 62 and/or that helps hold display 62 to device 10A) if desired. Peripheral structures 12AW may, if desired, form sidewall structures for device 10A (e.g., by forming a metal band with vertical sidewalls, curved sidewalls, etc.).

Peripheral structures 12AW may be formed of a conductive material such as metal and may therefore sometimes be referred to as peripheral conductive housing structures, conductive housing structures, peripheral metal structures, peripheral conductive sidewalls, peripheral conductive sidewall structures, conductive housing sidewalls, peripheral conductive housing sidewalls, sidewalls, sidewall structures, or a peripheral conductive housing member (as examples). Peripheral conductive housing structures 12AW may be formed from a metal such as stainless steel, aluminum, alloys, or other suitable materials. One, two, or more than two separate structures may be used in forming peripheral conductive housing structures 12AW.

It is not necessary for peripheral conductive housing structures 12AW to have a uniform cross section. For example, the top portion of peripheral conductive housing structures 12AW may, if desired, have an inwardly protruding ledge that helps hold display 62 in place. The bottom portion of peripheral conductive housing structures 12AW may also have an enlarged lip (e.g., in the plane of the rear surface of device 10A). Peripheral conductive housing structures 12AW may have substantially straight vertical sidewalls, may have sidewalls that are curved, or may have other suitable shapes. In some configurations (e.g., when peripheral conductive housing structures 12AW serve as a bezel for display 62), peripheral conductive housing structures 12AW may run around the lip of housing 12A (e.g., peripheral conductive housing structures 12AW may cover only the edge of housing 12A that surrounds display 62 and not the rest of the sidewalls of housing 12A).

Rear housing wall 12AR may lie in a plane that is parallel to display 62. In configurations for device 10A in which some or all of rear housing wall 12AR is formed from metal, it may be desirable to form parts of peripheral conductive housing structures 12AW as integral portions of the housing structures forming rear housing wall 12AR. For example, rear housing wall 12AR of device 10A may include a planar metal structure and portions of peripheral conductive housing structures 12AW on the sides of housing 12A may be formed as flat or curved vertically extending integral metal portions of the planar metal structure (e.g., housing structures 12AR and 12AW may be formed from a continuous piece of metal in a unibody configuration). Housing structures such as these may, if desired, be machined from a block of metal and/or may include multiple metal pieces that are assembled together to form housing 12A. Rear housing wall 12AR may have one or more, two or more, or three or more portions. Peripheral conductive housing structures 12AW and/or conductive portions of rear housing wall 12AR may form one or more exterior surfaces of device 10A (e.g., surfaces that are visible to a user of device 10A) and/or may be implemented using internal structures that do not form exterior surfaces of device 10A (e.g., conductive housing structures that are not visible to a user of device 10A such as conductive structures that are covered with layers such as thin cosmetic layers, protective coatings, and/or other coating/cover layers that may include dielectric materials such as glass, ceramic, plastic, or other structures that form the exterior surfaces of device 10A and/or serve to hide peripheral conductive housing structures 12AW and/or conductive portions of rear housing wall 12AR from view of the user).

Display 62 may have an array of pixels that form an active area that displays images for a user of device 10A. For example, the active area may include an array of display pixels. The array of pixels may be formed from liquid crystal display (LCD) components, an array of electrophoretic pixels, an array of plasma display pixels, an array of organic light-emitting diode display pixels or other light-emitting diode pixels, an array of electrowetting display pixels, or display pixels based on other display technologies. If desired, the active area may include touch sensors such as touch sensor capacitive electrodes, force sensors, or other sensors for gathering a user input.

Display 62 may be protected using a display cover layer such as a layer of transparent glass, clear plastic, transparent ceramic, sapphire, or other transparent crystalline material, or other transparent layer(s). The display cover layer may have a planar shape, a convex curved profile, a shape with planar and curved portions, a layout that includes a planar main area surrounded on one or more edges with a portion that is bent out of the plane of the planar main area, or other suitable shapes. The display cover layer may cover the entire front face of device 10A. In another suitable arrangement, the display cover layer may cover substantially all of the front face of device 10A or only a portion of the front face of device 10A. Openings may be formed in the display cover layer. For example, an opening may be formed in the display cover layer to accommodate a button. An opening may also be formed in the display cover layer to accommodate ports such as a speaker port or a microphone port. Openings may be formed in housing 12A to form communications ports (e.g., an audio jack port, a digital data port, etc.) and/or audio ports for audio components such as a speaker and/or a microphone if desired.

Display 62 may include conductive structures such as an array of capacitive electrodes for a touch sensor, conductive lines for addressing pixels, driver circuits, etc. Housing 12A may include internal conductive structures such as metal frame members and a planar conductive housing member (sometimes referred to as a conductive support plate or backplate) that spans the walls of housing 12A (e.g., a substantially rectangular sheet formed from one or more metal parts that is welded or otherwise connected between opposing sides of peripheral conductive housing structures 12AW). The conductive support plate may form an exterior rear surface of device 10A or may be covered by a dielectric cover layer such as a thin cosmetic layer, protective coating, and/or other coatings that may include dielectric materials such as glass, ceramic, plastic, or other structures that form the exterior surfaces of device 10A and/or serve to hide the conductive support plate from view of the user (e.g., the conductive support plate may form part of rear housing wall 12AR). Device 10A may also include conductive structures such as printed circuit boards, components mounted on printed circuit boards, and other internal conductive structures. These conductive structures, which may be used in forming a ground plane in device 10A, may extend under the active area of display 62, for example.

If desired, openings may be formed within the conductive structures of device 10A (e.g., between peripheral conductive housing structures 12AW and opposing conductive ground structures such as conductive portions of rear housing wall 12AR, conductive traces on a printed circuit board, conductive electrical components in display 62, etc.). These openings, which may sometimes be referred to as gaps, may be filled with air, plastic, and/or other dielectrics and may be used in forming slot antenna resonating elements for one or more antennas in device 10A, if desired.

In general, device 10A may include any suitable number of antennas (e.g., one or more, two or more, three or more, four or more, etc.). The antennas in device 10A may be located at opposing first and second ends of an elongated device housing, along one or more edges of a device housing, in the center of a device housing, in other suitable locations, or in one or more of these locations.

Portions of peripheral conductive housing structures 12AW may be provided with peripheral gap structures. For example, peripheral conductive housing structures 12AW may be provided with one or more dielectric-filled gaps such as gaps 68, as shown in FIG. 2. The gaps in peripheral conductive housing structures 12AW may be filled with dielectric such as polymer, ceramic, glass, air, other dielectric materials, or combinations of these materials. Gaps 68 may divide peripheral conductive housing structures 12AW into one or more peripheral conductive segments. The conductive segments that are formed in this way may form parts of antennas in device 10A if desired. Other dielectric openings may be formed in peripheral conductive housing structures 12AW (e.g., dielectric openings other than gaps 68) and/or may be formed in rear wall 12AR and may serve as dielectric antenna windows for antennas mounted within the interior of device 10A. Antennas within device 10A may be aligned with the dielectric antenna windows for conveying radio-frequency signals through housing 12A.

In some scenarios, device 10A may have one or more upper antennas and one or more lower antennas. An upper antenna may, for example, include an antenna resonating element formed from a segment of peripheral conductive housing structures 12AW at the upper end of device 10A (e.g., extending between gaps 68). A lower antenna may, for example, include an antenna resonating element formed from a segment of peripheral conductive housing structures 12AW at the lower end of device 10A (e.g., extending between gaps 68). Upper and lower antennas may, for example, be used to convey radio-frequency signals 48 of FIG. 1. The antennas may be used separately to cover identical communications bands, overlapping communications bands, or separate communications bands. The antennas may be used to implement an antenna diversity scheme or a multiple-input-multiple-output (MIMO) antenna scheme.

Other antennas for covering any other desired frequencies may also be mounted at any desired locations within the interior of device 10. For example, one or more antennas in device 10 may be aligned with a dielectric antenna window in a conductive portion of rear housing wall 12AR. These antennas may convey radio-frequency signals through the dielectric antenna window in rear housing wall 12AR to support short range communications link 52 (FIG. 1) when device 10A is mounted to device 10B. The example of FIG. 1 is merely illustrative. If desired, housing 12A may have other shapes (e.g., a square shape, cylindrical shape, spherical shape, combinations of these and/or different shapes, etc.). Housing 12B of device 10B may have a triangular shape or other shapes (e.g., a planar/mat shape).

Device 10B may include one or more antennas overlapping a surface such as receiving surface 60. Receiving surface 60 may, for example, be the exterior surface of a wall of the housing 12B of device 10B (FIG. 1). The wall of housing 12B that includes receiving surface 60 may have a dielectric portion (e.g., a dielectric antenna window surrounded by a conductive portion of receiving surface 60). One or more antennas in device 10B may be mounted within housing 12B overlapping the dielectric portion. The antennas may convey radio-frequency signals through receiving surface 60 to support short range wireless communications link 52 (FIG. 1) when device 10A is mounted to device 10B.

When device 10A is mounted to device 10B (e.g., by a user), rear housing wall 12AR of device 10A contacts receiving surface 60 of device 10B. If desired, alignment structures (not shown) may be included in device 10B (e.g., on receiving surface 60 or within housing 12B) and/or device 10A (e.g., on rear housing wall 12AR or within housing 12A) to hold device 10A in place on receiving surface 60 in a desired orientation. The alignment structures may include one or more grooves, protrusions, clips, pins, lips, brackets, and/or magnets, as examples. If desired, the alignment structures may hold device 10A in an orientation in which the antenna(s) in device 10A that support short range wireless communications link 52 (FIG. 1) and the antenna(s) in device 10B that support short range wireless communications link 52 are aligned with each other.

When mounted to receiving surface 60, device 10B may dock device 10A to monitor 56. While docked, device 10A may have a relatively high amount of data to transfer to device 10B and monitor 56. As such, relatively high data rates may be needed to convey data between device 10A and device 10B. Short range wireless communications link 52 (FIG. 1) may therefore be used to convey wireless data between device 10A and device 10B using an IBFD scheme (e.g., by simultaneously conveying corresponding radio-frequency signals in the same frequency band in both directions between device 10A and 10B).

Device 10B may convey some of the wireless data to monitor 56 over cable 58. Monitor 56 may output the wireless data received from device 10A via device 10B and cable 58. For example, device 10A may transmit high definition video data (e.g., a 4K, 8K, or higher resolution video stream of the content being displayed on display 62 of device 10A). Additionally or alternatively, device 10A may transmit audio data (e.g., a high fidelity audio stream of audio data being played by a speaker or headphones of device 10A) to device 10B over short range wireless communications link 52. Device 10B may transmit the video and/or audio data to monitor 56 over cable 58. A display driver on monitor 56 may display the video data using the display of monitor 56. A speaker on monitor 56 may play back the audio data.

In this way, by docking device 10A to device 10B, the user of device 10A may continue to interact with device 10A as if device 10A were a desktop computer having monitor 56. For example, a user may be using a software application to perform a task on device 10A prior to docking device 10A to device 10B (e.g., reading email, surfing the web, playing video, playing audio, editing a document or file, or performing any other tasks while traveling to the location of monitor 56). When the user docks device 10A to device 10B, device 10B may use short range wireless communications link 52 and cable 58 to effectively continue the task being performed on device 10A on monitor 56 (e.g., so the user can continue to interact with the software application as if interacting with a desktop computer having monitor 56). The high data rates supported by short range wireless communications link 52 (e.g., about 5-10 Gbps or higher) may allow for the user to interact with device 10A by viewing content, on monitor 56 that would otherwise be displayed on display 62, with minimal latency and maximum quality.

If desired, while device 10A is docked to device 10B, external devices 64 and/or 66 may be used to provide user input to device 10A (e.g., via Bluetooth signals conveyed between the external devices and device 10A or via Bluetooth signals conveyed between the external devices and monitor 56, which then forwards the user input to device 10A via cable 58, device 10B, and short range wireless communications link 52). If desired, while device 10A is docked to device 10B, the coil(s) 44 on device 10B (FIG. 1) may transmit wireless power signals 50 to the coil(s) 34 on device 10A to power or charge device 10A. The coil(s) 44 on device 10B may, for example, transmit wireless power signals 50 through a dielectric portion of receiving surface 60. Similarly, the coil(s) 34 on device 10A may receive wireless power signals 50 through a dielectric portion of rear housing wall 12AR. The alignment structures in device 10A and/or device 10B may help to align coil(s) 34 on device 10A with the coil(s) 44 on device 10B if desired.

The example of FIG. 2 is illustrative and non-limiting. If desired, cable 58 may be replaced with a wireless communications link between monitor 56 and device 10B. Monitor 56 may be replaced with any desired external device. Device 10B may be replaced with any desired device that communicates with device 10A over short range communications link 52 when device 10A is mounted to receiving surface 60 (e.g., any device requiring the high speed capability of short range communications link 52 for conveying data between devices 10A and 10B). Housings 12A and 12B may have other shapes and/or sizes. Device 10A need not include a display. Device 10B may include a display if desired.

When device 10A is mounted to device 10B, short range wireless communications link 52 may be used to perform high speed wireless data transfer between devices 10A and 10B (e.g., at data rates of about 5-10 Gbps or higher). The high speed wireless data transfer may be as fast or faster than wireless data transfer over a data transfer cable that is physically connected between devices 10A and 10B. However, short range wireless communications link 52 does not require a data transfer cable between devices 10A and 10B, does not require a user to physically connect a data transfer cable to either device, and minimizes the amount of attention paid by the user to convey data between devices 10A and 10B (which may optimize user experience).

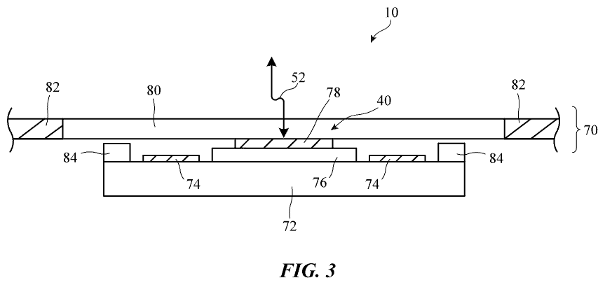

FIG. 3 is a cross-sectional side view of a given device 10, showing how antenna(s) 40 on the device may convey radio-frequency signals through a housing wall to support short range wireless communications link 52. As shown in FIG. 3, device 10 (e.g., device 10A or device 10B of FIG. 1) may have a housing wall 70 (e.g., rear housing wall 12AR of device 10A or a wall of housing 12B of device 10B that includes receiving surface 60). Housing wall 70 is sometimes also referred to herein as cover layer 70 or cover 70.

Housing wall 70 may have a dielectric portion 80 (e.g., a dielectric antenna window). If desired, housing wall 70 may include conductive portions 82 that surround dielectric portion 80. Dielectric portion 80 may be formed from glass, plastic, ceramic, sapphire, or other dielectric materials. Alternatively, housing wall 70 may be formed entirely from dielectric materials.

One or more antennas 40 may be formed from conductive traces 78 on an underlying substrate 76. Substrate 76 may be a flexible printed circuit, a rigid printed circuit, or another dielectric antenna carrier or substrate, as examples. Substrate 76 may include one or more stacked dielectric layers. Conductive traces 78 may be patterned onto an outermost surface of substrate 76 and/or may be embedded within the stacked dielectric layers of substrate 76. Conductive traces 78 may form the antenna resonating element for antenna(s) 40 and/or part of the ground plane for antenna(s) 40. The antenna resonating element may be a patch antenna resonating element or other types of resonating elements. The antenna resonating element may be coupled to the signal conductor of the corresponding radio-frequency transmission line 31 (FIG. 1) at a positive antenna feed terminal. The ground plane may be coupled to the ground conductor of the corresponding radio-frequency transmission line 31 at a ground antenna feed terminal.

Substrate 76 and/or conductive traces 78 may be pressed against the interior surface of housing wall 70. Alternatively, an air gap or a layer of pressure-sensitive adhesive (PSA) may be present between substrate 76 (or conductive traces 78) and the interior surface of housing wall 70. If desired, substrate 76 may be mounted to module 72. Module 72 may include one or more substrates, rigid printed circuit boards, flexible printed circuits, integrated circuits (ICs), packages, etc. Module 72 may include coil 74 (e.g., coil 34 of device 10A or coil 44 of device 10B as shown in FIG. 1). Coil 74 may laterally extend around or surround substrate 76, conductive traces 78, and/or antenna 40. Alignment structures such as magnets 84 may be disposed on module 72 and/or dielectric portion 80 of housing wall 70.

When an external device (e.g., device 10A or 10B of FIG. 1) is mounted to or placed against housing wall 70, antenna(s) 40 may convey radio-frequency signals with the external device over short range wireless communications link 52. The example of FIG. 3 is illustrative and non-limiting. If desired, substrate 76 and antenna 40 may be embedded within the layers of module 72. Alternatively, substrate 76 may be omitted and conductive traces 78 may be patterned directly onto and/or within module 72. Integrating antenna 40 with module 72 in this way may help to minimize space consumption within device 10 while allowing device 10 to both convey wireless data over short range wireless communications link 52 and convey wireless power signals through dielectric portion 80 of housing wall 70.

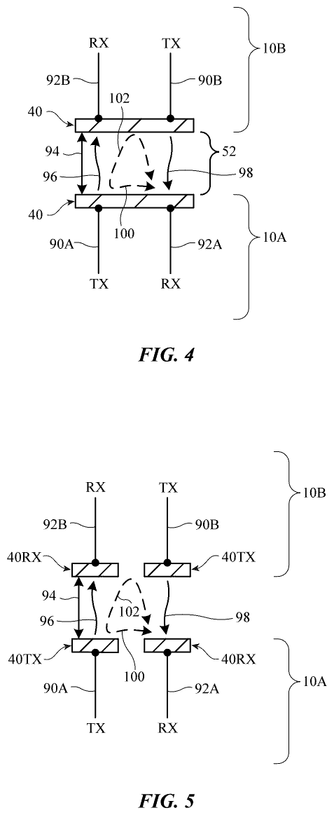

FIG. 4 is a schematic side view showing how devices 10A and 10B may convey radio-frequency signals over short range wireless communications link 52 under an in-band full duplex scheme. In the example of FIG. 4, device 10A and device 10B each include a single respective antenna 40 for supporting wireless communications link 52. When device 10A is mounted to device 10B, the antenna 40 in device 10A may be separated from the antenna 40 in device 10B by distance 94 (e.g., less than 10 cm, less than 5 cm, less than 1 cm, less than 0.5 cm, less than 10 mm, etc.).

As shown in FIG. 4, the antenna 40 in device 10A may have a transmit (TX) port (feed) 90A and a receive (RX) port (feed) 92A coupled to the antenna resonating element of antenna 40. Similarly, the antenna 40 in device 10B may have a transmit port (feed) 90B and a receive port (feed) 92B coupled to the antenna resonating element of antenna 40. Short range wireless communications link 52 include a first stream of wireless data conveyed by radio-frequency signals 96 transmitted from transmit port 90A on device 10A to receive port 92B on device 10B. Short range communications link 52 further includes a second stream of wireless data conveyed by radio-frequency signals 98 transmitted from transmit port 90B on device 10B to receive port 92A of device 10A.

Under the in-band full duplex scheme, radio-frequency signals 96 and 98 are concurrently (simultaneously) transmitted within the same frequency band (e.g., 57-64 GHZ). While the in-band full duplex scheme supports increased data rates, concurrent transmission and reception in the same frequency band can cause undesirable signal leakage from the transmit port onto the receive port of device 10A and/or device 10B. For example, as shown in FIG. 4, some of radio-frequency signals 96 may leak from transmit port 90A directly onto receive port 92A in device 10A (as shown by arrow 100). Additionally or alternatively, some of radio-frequency signals 96 may reflect off the antenna 40 in device 10B, back towards device 10A, and onto receive port 92A (as shown by arrow 102). Similar leakage may occur at device 10B. This signal leakage can reduce the sensitivity of device 10A and/or device 10B, can introduce errors to the transmitted and/or received signals, and can otherwise deteriorate the wireless performance of devices 10A and/or 10B.

To help mitigate these issues, device 10A and device 10B may include separate transmit and receive antennas, as shown in the example of FIG. 5. As shown in FIG. 5, device 10B may include a transmit antenna 40TX having a first antenna resonating element (e.g., a first radiating patch) coupled to transmit port 90B and may include a receive antenna 40RX having a second antenna resonating element (e.g., a second radiating patch) that is coupled to receive port 92B and that is separated from the first antenna resonating element by a non-zero distance. Similarly, device 10A may include a transmit antenna 40TX having a first antenna resonating element (e.g., a third radiating patch) coupled to transmit port 90A and may include a receive antenna 40RX having a second antenna resonating element (e.g., a fourth radiating patch) that is coupled to receive port 92A and that is separated from the first antenna resonating element by a non-zero distance. The examples of FIGS. 4 and 5 are illustrative and non-limiting. If desired, one of devices 10A and 10B may include a single antenna 40 coupled to a corresponding transmit port 90 and receive port 92 (FIG. 4) whereas the other of devices 10A and 10B includes a transmit antenna 40TX coupled to a corresponding transmit port 90 and a receive antenna 40RX coupled to a corresponding receive port 92 (FIG. 5).

By coupling the transmit and receive ports to separate antennas, each device 10 may reduce signal leakage from its transmit port 90 onto its receive port 92 (e.g., the signal leakage associated with arrow 100). However, in practice, some signal leakage associated with arrow 100 will still be present, as well as the signal leakage associated with arrow 102. If desired, the antenna(s) 40 that convey radio-frequency signals 96 and/or 98 for short range wireless communications link 52 may be provided with an overlapping waveguide that helps to mitigate the signal leakage associated with arrows 100 and 102.

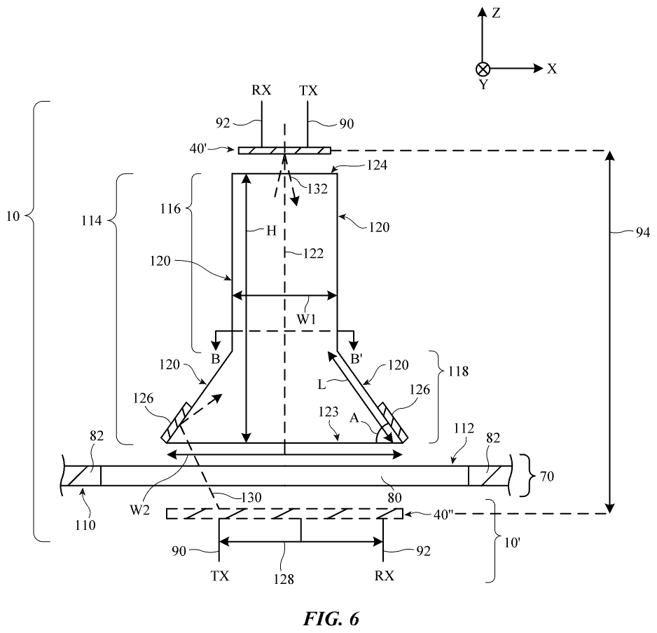

FIG. 6 is a cross-sectional side view showing one example of how the antenna(s) that support short range wireless communications link 52 for a given device 10 may be provided with an overlapping waveguide that helps mitigate signal leakage during in-band full duplex operations. As shown in FIG. 6, device 10 may include one or more antennas 40′ for supporting short range wireless communications link 52 with one or more antennas 40″ in an external device 10′. Antennas 40′ may be aligned with the dielectric portion 80 of a housing wall 70 on device 10. The housing of external device 10′ is not shown in FIG. 6 for the sake of clarity.

In a first configuration, device 10 of FIG. 6 is device 10B and device 10′ is device 10A of FIG. 1 (e.g., antenna(s) 40′ are the antenna(s) 40 of device 10B and antenna(s) 40″ are the antenna(s) 40 of device 10A used to support short range wireless communications link 52). In this configuration, housing wall 70 is a housing wall of housing 12B (FIGS. 1 and 2) and the exterior surface 110 of housing wall 70 may form receiving surface 60 (FIG. 2). In a second configuration, device 10 of FIG. 6 is device 10A and device 10′ is device 10B of FIG. 1 (e.g., antenna(s) 40′ are the antenna(s) 40 of device 10A and antenna(s) 40″ are the antenna(s) 40 of device 10B used to support short range wireless communications link 52). In this configuration, housing wall 70 may form rear housing wall 12AR of housing 12A (FIG. 2).

While illustrated using a single rectangle in FIG. 6 for the sake of clarity, antenna(s) 40′ may include a single antenna 40 coupled to both a corresponding transmit port 90 and receive port 92 (e.g., as shown in FIG. 4) or may include a transmit antenna 40TX coupled to transmit port 90 and a receive antenna 40RX coupled to receive port 92 (e.g., as shown in FIG. 5). Similarly, antenna(s) 40″ may include a single antenna 40 coupled to both a corresponding transmit port 90 and receive port 92 in external device 10′ or may include a transmit antenna 40TX coupled to transmit port 90 and a receive antenna 40RX coupled to receive port 92.

As shown in FIG. 6, device 10′ may include a radio-frequency electromagnetic waveguide overlapping antenna(s) 40′ such as waveguide 114. Waveguide 114 may be interposed between antenna(s) 40′ and housing wall 70. Waveguide 114 may extend from a first end (surface or face) 124 that faces antenna(s) 40′ to an opposing second end (surface or face) 123 that faces housing wall 70 and external device 10′. Waveguide 114 may have a height H measured linearly (e.g., orthogonally) from end 124 to end 123 (e.g., parallel to the Z-axis).

Waveguide 114 may have a first (straight) portion such as elongated portion 116 and a second (tapered) portion such as horn 118. Elongated portion 116 (sometimes also referred to herein as linear portion 116) extends from end 124 to horn 118 along longitudinal axis 122. Horn 118 extends from elongated portion 116 to end 123 (e.g., along longitudinal axis 122).

Waveguide 114 may have sidewalls 120 that extend from end 124 to end 123. Sidewalls 120 may extend laterally around longitudinal axis 122. Within elongated portion 116 of waveguide 114, sidewalls 120 may extend parallel to longitudinal axis 122 and height H (e.g., orthogonal to end 124 and end 123). Within horn 118, sidewalls 120 extend at non-parallel angles with respect to longitudinal axis 122 (e.g., non-orthogonal angles A with respect to end 124). Horn 118 has a first end at elongated portion 116 that is narrower than the opposing second end of horn 118, which forms end 123 of waveguide 114.

Elongated portion 116 of waveguide 114 may have a first width (diameter) W₁ (e.g., as measured orthogonally between opposing sidewalls 120 of elongated portion 116 and parallel to the X-axis). End 124 may also have width W1. Horn 118 may extend or taper from width W1 where horn 118 meets elongated portion 116 to a different width W2 (e.g., as measured between opposing sidewalls 120 of horn 118 parallel to the X-axis) at end 123. Width W₂ is greater than width W1. The portion of sidewalls 120 on horn 118 may have horn length L (e.g., as measured from end 123 to where elongated portion 116 meets horn 118). Horn 118 may taper from width W1 to width W2 continuously (as shown in FIG. 6) or discontinuously (e.g., in a series of discrete steps of increasing width).

In general, width W1 may be selected to satisfy the equation f_{c}=1.8412*c/(πW), where c is the speed of light, W is width W1, and f_{c} is the cut-off frequency of the radio-frequency signals conveyed by waveguide 114. To optimize propagation of radio-frequency signals at around 60 GHz through waveguide 114, width W1 may be greater than or equal to 3-3.5 mm, for example. Horn length L may be selected to be approximately equal to (W₂)²/(3*λ), for example, where A is the effective wavelength of the radio-frequency signals propagated by waveguide 114. The effective wavelength is equal to the vacuum wavelength as modified by a constant value selected based on the dielectric constant of materials inside waveguide 114. If desired, horn length L and one or both of the widths of waveguide 114 may be reduced as the effective dielectric constant of the volume of waveguide 114 increases.

End 123 of waveguide 114 may be separated from the interior surface 112 of housing wall 70 by an air gap or pressure-sensitive adhesive (PSA) or may, if desired, be pressed against interior surface 112 of housing wall 70. If desired, one or more additional dielectric layers (not shown) such as impedance matching (transition) layers may be interposed between waveguide 114 and housing wall 70.

Waveguide 114 may be formed from a solid dielectric material such as plastic, polymer, ceramic, or other materials. The solid dielectric material may be hollow (e.g., waveguide 114 may have walls formed from the solid dielectric material where the volume of waveguide 114 is filled with air) or may, if desired, extend throughout the entire volume of waveguide 114. If desired, waveguide 114 may be formed from multiple dielectric materials. Filling the volume of waveguide 114 with solid dielectric material may serve to increase the effective dielectric constant of waveguide 114, allowing for a reduction in the size of waveguide 114 without sacrificing performance.

If desired, conductive (e.g., metal) material such as conductive traces 126 may be layered or patterned onto some or all of one or more of the sidewalls 120 of waveguide 114. For example, conductive traces 126 may be layered onto some or all of the sidewalls 120 of horn 118 and/or some or all of the sidewalls 120 of elongated portion 16. In the example of FIG. 6, conductive traces 126 are layered onto the sidewalls 120 of horn 118 along some but not all of horn length L. While described herein as conductive traces, conductive traces 126 may be replaced with metal foil, sheet metal, or metal plating on sidewalls 120 if desired.

When external device 10′ is mounted to device 10 (e.g., when device 10A is docked to device 10B of FIG. 1), the antenna(s) 40″ on external device 10′ are separated from the antenna(s) 40′ on device 10 by distance 94. Antenna(s) 40″ overlap dielectric portion 80 of housing wall 70 and end 123 of the horn 118 of waveguide 114 (e.g., when viewed in the −Z direction). Antennas 40′ and 40″ may then convey radio-frequency signals 96 and 98 to support short range wireless communications link 52 (FIGS. 4 and 5).

When short range wireless communications link 52 is active, the transmit port 90 of antenna(s) 40″ in external device 10′ transmits radio-frequency signals 96 (FIGS. 4 and 5) through dielectric portion 80 of housing wall 70, into horn 118 of waveguide 114 through end 123. Waveguide 114 propagates radio-frequency signals 96 down its length (e.g., in one or more waveguide propagation modes), from horn 118 into elongated portion 116, and from elongated portion 116 through end 124 to antenna(s) 40′. Antenna(s) 40′ may pass the received radio-frequency signals to the corresponding radio 26 (FIG. 1) over the receive port 90 coupled to antenna(s) 40′.

The angled sidewalls 120 of horn 118 may help to reflect radio-frequency signals 96 incident upon waveguide 114 at relatively high angles back towards the center of waveguide 114 (e.g., longitudinal axis 122) and towards elongated portion 116, as shown by arrow 130. This may, for example, help to prevent radio-frequency signals at high angles from leaking onto the receive port 92 of external device 10′ (e.g., as shown by arrow 100 in FIGS. 4 and 5) and/or from reflecting unpredictably off of antenna(s) 40′ (e.g., helping to minimize the signal leakage shown by arrow 102 in FIGS. 4 and 5).

Conductive traces 126 may serve to increase the radio-frequency reflectivity of the sidewalls 120 of horn 118 to maximize the amount of high angle radio-frequency signals 96 that is reflected back towards the center of waveguide 114. By disposing conductive traces 126 on some but not all of the horn length L of horn 118, conductive traces 126 may exhibit a reduced cross section (e.g., when projected onto the X-Y plane) that serves to minimize the impact of conductive traces 126 on wireless power signals 50 conveyed by coil(s) 34 and 44 (FIG. 1) through dielectric portion 80 of housing wall 70.

In addition, elongated portion 116 may serve to laterally constrain the propagation of radio-frequency signals 96 upon exiting waveguide 114 and/or to laterally constrain the propagation of radio-frequency signals 96 after reflection off antenna(s) 40′ and back towards antenna(s) 40″ (e.g., as shown by arrow 132). This may help to prevent the reflected radio-frequency signals 96 from being incident upon the receive port 92 of external device 10′, which may assist in minimizing signal leakage from the transmit port 90 of external device 10′ onto the receive port 92 of external device 10′ after reflection off antenna(s) 40′ (e.g., helping to minimize the signal leakage shown by arrow 102 in FIGS. 4 and 5).

Further, the presence of horn 118 on waveguide 114 may allow the transmit port 90 and the receive port 92 (or equivalently the transmit antenna 40TX and the receive antenna 40RX) of external device 10′ to be laterally separated from each other by a separation 128 that is greater than in implementations where waveguide 114 includes only a single linear segment such as elongated portion 116. For example, the angled sidewalls 120 and the conductive traces 126 may help to reflect, back into waveguide 114 and elongated portion 116), the transmitted radio-frequency signals 96 that would have otherwise escaped a linear waveguide when the transmit and receive ports on external device 10′ are separated by separation 128. The increased separation 128 between the transmit port 90 and the receive port 92 on external device 10′ may serve to further reduce direct signal leakage from the transmit port directly onto the receive port (e.g., as shown by arrow 100 in FIGS. 4 and 5).

When external device 10′ is mounted to device 10, antenna(s) 40″ on external device 10′ are vertically separated from end 123 of waveguide 114 by a distance greater than the far-field limit associated with antenna(s) 40″. When transmitting radio-frequency signals 96 (FIGS. 4 and 5), radio-frequency signals 96 propagate from antenna(s) 40″ in the near-field domain (e.g., as non-radiative, non-plane waves) at distances less than the far-field limit and in the far field domain (e.g., as radiative plane waves) at distances greater than the far-field limit. The distance from end 123 of waveguide 114 and housing wall 70, the thickness of housing wall 70, the thickness of the housing wall of external device 10′ (not shown), and the separation between antenna(s) 40″ and the housing wall of external device 10′ may, for example, be selected such that end 123 is separated from antenna(s) 40″ by a distance greater than the far-field limit. This may, for example, serve to minimize the impact of conductive traces 126 on the radiation of radio-frequency signals 96 by antenna(s) 40″, instead configuring the conductive traces 126 to form a reflector that reflects the already-radiated plane waves of radio-frequency signals back into the body of waveguide 114.

Waveguide 114 is a non-radiative waveguide that propagates plane waves of radio-frequency signals between antenna(s) 40′ and 40″. Waveguide 114 is not a dielectric resonator antenna (DRA) or a dielectric resonating element. Dielectric resonator antennas and dielectric resonating elements are electrically fed by a feed (e.g., a probe feed that contacts the dielectric resonator antenna) that excites electromagnetic resonant modes of the dielectric resonator antenna or dielectric resonating element, causing the dielectric resonator antenna or dielectric resonating element itself to radiate. On the other hand, waveguide 114 is not electrically driven, fed, or excited by any feed and does not contribute electromagnetic resonant modes to the radiative response of antenna(s) 40′ or antenna(s) 40″.

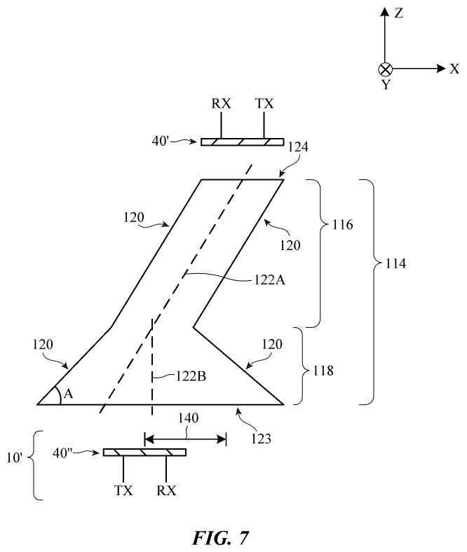

In the example of FIG. 6, elongated portion 116 and horn 118 of waveguide 114 each extend along the same longitudinal axis 122 (e.g., extending through the center of elongated portion 116 and horn 118 when viewed in the −Z direction). If desired, horn 118 and elongated portion 116 may extend along different non-parallel longitudinal axes. FIG. 7 is a cross-sectional side view showing one example of how horn 118 and elongated portion 116 may extend along different non-parallel longitudinal axes. In the example of FIG. 7, housing wall 70 and conductive traces 126 of FIG. 6 have been omitted for the sake of clarity.

As shown in FIG. 7, elongated portion 116 of waveguide 114 may extend along a first longitudinal axis 122A (e.g., extending through the center of elongated portion 116 and end 124 in parallel with the sidewalls 120 of elongated portion 116). Longitudinal axis 122A may, for example, extend at a non-orthogonal angle with respect to end 124, end 123, and/or the plane of antenna(s) 40′ (whereas end 124 extends parallel to end 123 and the plane of antenna(s) 40′ and 40″).

On the other hand, horn 118 of waveguide 114 may have a second longitudinal axis 122B (e.g., extending through the center of horn 118 and end 123 in parallel with the Z-axis and orthogonal to ends 123 and 124). Longitudinal axis 122B may extend at a non-parallel angle with respect to longitudinal axis 122A (e.g., 1-89 degrees). Bending waveguide 114 between elongated portion 116 and horn 118 in this way may allow antenna(s) 40″ on external device 10′ to convey radio-frequency signals with antenna(s) 40′ on device 10 through waveguide 114 even when antenna(s) 40″ are not precisely aligned with antenna(s) 40′. For example, when external device 10′ is mounted to device 10, antenna(s) 40′ may be laterally offset from antenna(s) 40″ by offset 140 (e.g., when viewed in the −Z direction). This may, for example, allow antenna(s) 40″ and 40′ to convey radio-frequency signals for short range wireless communications link 52 (FIGS. 1, 4, and 5) under a wide range of different form factors for device 10 and external device 10′ (e.g., allowing for other components to be disposed in device 10 and/or external device 10′ that would otherwise prevent antenna(s) 40′ and 40″ from being precisely aligned with each other).

The example of FIG. 7 is illustrative and non-limiting. If desired, waveguide 114 may include multiple elongated segments 116 coupled together in series, each extending along a different non-parallel longitudinal axis (e.g., waveguide 114 may follow a meandering path having any desired number of segments at any desired angles from horn 118 to antenna(s) 40′).

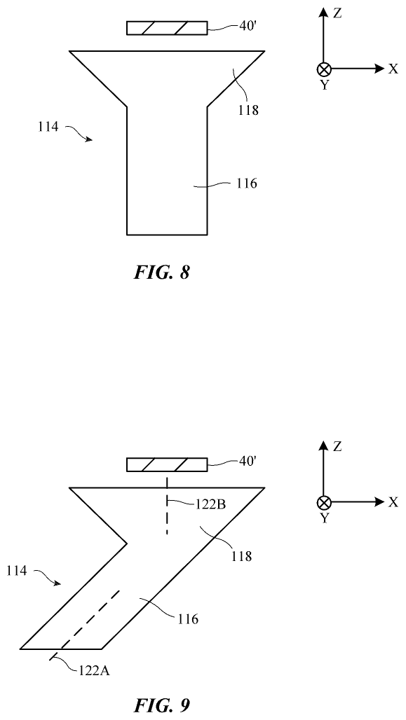

The examples of FIGS. 6 and 7 in which horn 118 of waveguide 114 faces external device 10′ and elongated portion 116 of waveguide 114 faces antenna(s) 40′ are illustrative and non-limiting. If desired, horn 118 of waveguide 114 may face antenna(s) 40′ and elongated portion 116 of waveguide 114 may face external device 10′ in implementations where horn 118 and elongated portion 116 share the same longitudinal axis (as shown in FIG. 8) and/or in implementations where horn 118 and elongated portion 116 have non-parallel longitudinal axes (as shown in FIG. 9).

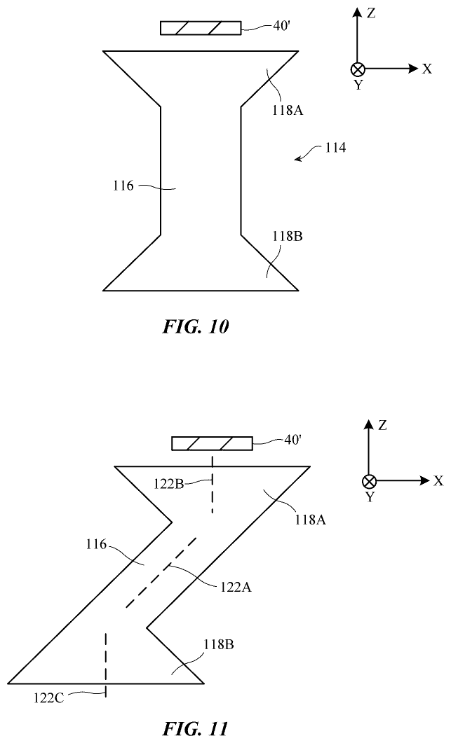

The examples of FIGS. 6-9 in which waveguide 114 includes a single horn 118 at a single end of elongated portion 116 are illustrative and non-limiting. If desired, waveguide 114 may include a first horn 118A at a first end of elongated portion 116 and a second horn 118B at a second end of elongated portion 116. For example, as shown in FIG. 10, waveguide 114 may include a first horn 118A having a wider end facing antenna(s) 40′, a second horn 118B having a wider end facing external device 10′, and an elongated portion 116 extending from the narrower end of horn 118A to the narrower end of horn 118B.

In the example of FIG. 10, horn 118A, horn 118B, and elongated portion 116 all share the same longitudinal axis. If desired, elongated portion 116 may have a first longitudinal axis 122A, horn 118A may have a second longitudinal axis 122B, and horn 11B may have a third longitudinal axis 122C, as shown in the example of FIG. 11. As shown in FIG. 11, longitudinal axis 122C may extend parallel to and may be laterally offset from longitudinal axis 122B. Longitudinal axis 122A may extend at a first non-parallel angle with respect to longitudinal axis 122B and at a second non-parallel angle with respect to longitudinal axis 122C.

In general, waveguide 114 may have other geometries. Sidewalls 120 may include any desired number of flat (planar) segments extending in any desired directions and at any desired angles. One or more of sidewalls 120 may be curved about one or more axes if desired. Waveguide 114 may have any desired cross-sectional shape (lateral outline) and thus any desired number of sidewalls 120. For example, waveguide 114 may have a circular cross section, an elliptical cross section, a rectangular cross section, or other polygonal cross sections. If desired, waveguide 114 may have different cross sectional shapes between elongated portion 116 and horn 118.

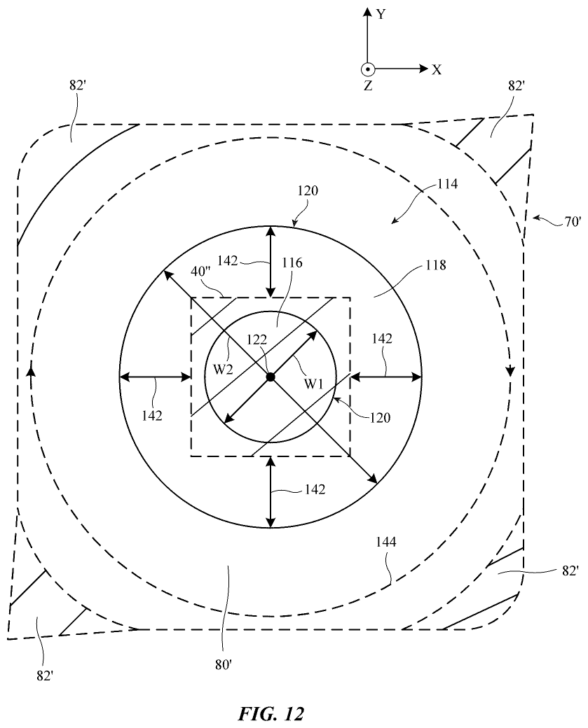

FIG. 12 is a cross-sectional top view in an example where horn 118 and elongated portion 116 of waveguide 114 extend along the same longitudinal axis 122 (e.g., as taken along line BB′ of FIG. 6). In the example of FIG. 12, housing wall 70, antenna(s) 40′, and conductive traces 126 have been omitted for the sake of clarity.

As shown in FIG. 12, antenna(s) 40″ may overlap a dielectric portion 80′ (e.g., a dielectric antenna window) of a housing wall 70′ on external device 10′. If desired, dielectric portion 80′ may be surrounded by a conductive portion 82′ of housing wall 70′. Antenna(s) 40″ may overlap dielectric portion 80′ of housing wall 70′. When device 10 is mounted to external device 10′, horn 118 of waveguide 114 overlaps antenna(s) 40″ in external device 10′. The angled sidewalls 120 of horn 118 may allow antenna(s) 40″ to transmit radio-frequency signals through waveguide 114 even when antenna(s) 40″ is/are not precisely aligned with the longitudinal axis 122 of waveguide 114. In other words, horn 118 may allow for a relatively large tolerance 142 in the positioning of antenna(s) 40″ with respect to antenna(s) 40′ (FIG. 6) while still supporting short range wireless communications link 52. This may, for example, allow for non-zero tolerances in the alignment structures used to hold external device 10′ in place on device 10 and/or may allow the user to place external device 10′ on device 10 without needing to take great effort or care in the precise placement or alignment of external device 10′.

In the example of FIG. 12, horn 118 and elongated portion 116 of waveguide 114 each have a circular cross section (e.g., where the width W2 of horn 118 extends across the diameter of the circular cross section of horn 118 and width W1 of elongated portion 116 extends across the diameter of the circular cross section of elongated portion 116). Put differently, horn 118 has a single curved sidewall 120 that follows a circular path around longitudinal axis 122 and elongated portion 116 has a single curved sidewall 120 that follows a circular path around longitudinal axis 122. The sidewalls 120 of horn 118 are angled, which configures horn 118 to exhibit a conical shape (e.g., horn 118 may be a cone-shaped or conical horn).

If desired, external device 10′ may include a wireless power transmitting or receiving coil 144 (e.g., coil 74 of FIG. 3, coil 34 of FIG. 1, coil 44 of FIG. 1, etc.). Coil 144 may overlap dielectric portion 80′ of housing wall 70′ and may be aligned with antenna(s) 40″. Coil 144 may, for example, wind at least once around a central opening (e.g., longitudinal axis 122). Antenna(s) 40″ and waveguide 114 may overlap the central opening.

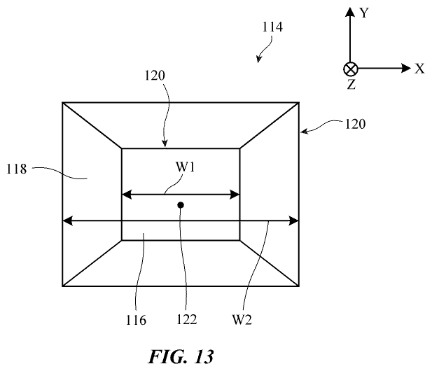

FIG. 13 is a cross-sectional top view of waveguide 114 in an implementation where horn 118 and elongated portion 116 each have a rectangular cross section. In the example of FIG. 13, the components of external device 10′, housing wall 70, conductive traces 126, and antenna(s) 40′ have been omitted for the sake of clarity).

As shown in FIG. 13, horn 118 may have a rectangular cross section (e.g., where width W2 of horn 118 extends parallel to the longest side of the rectangular cross section). As such, horn 118 has four sidewalls 120 that follow a rectangular path around longitudinal axis 122. The sidewalls 120 of horn 118 are angled, which configures horn 118 to exhibit a pyramidal shape (e.g., horn 118 may be a pyramid-shaped or pyramidal horn).

Similarly, elongated portion 116 may have a rectangular cross section (e.g., where width W1 of elongated portion 116 extends parallel to the longest side of the rectangular cross section). As such, elongated portion 116 has four sidewalls 120 that follow a rectangular path around longitudinal axis 122. The sidewalls 120 of elongated portion 116 may, for example, extend parallel to the X-Z plane or the Y-Z plane of FIG. 13.

These examples are illustrative and non-limiting. In general, waveguide 114 (e.g., horn 118 and/or elongated portion 116) may have other cross sectional shapes or outlines and any desired number of sidewalls 120. For example, waveguide 114 may have a hexagonal cross section, a pentagonal cross section, an octagonal cross section, other polygonal cross sections, an elliptical cross section, combinations of these, and/or any other desired cross sections or shapes.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

Devices 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users. The foregoing is merely illustrative and various modifications can be made to the described embodiments. The foregoing embodiments may be implemented individually or in any combination.

What is claimed is:

1. An electronic device comprising:
a housing wall;
one or more antennas having a transmit port and a receive port; and
a waveguide between the housing wall and the one or more antennas, the the transmit port and the receive port being configured to concurrently convey, through the waveguide and the housing wall, first and second streams of wireless data under an in-band full duplex scheme.

2. The electronic device of claim 1, wherein the waveguide has an elongated portion with a first width and a horn that extends, from the elongated portion, to an opposing end having a second width greater than the first width.

3. The electronic device of claim 2, wherein the elongated portion faces the one or more antennas and the horn faces the housing wall.

4. The electronic device of claim 2, wherein the horn has angled sidewalls, the electronic device further comprising:
conductive traces on the angled sidewalls.

5. The electronic device of claim 4, wherein the conductive traces cover some but not all of the angled sidewalls.

6. The electronic device of claim 2, wherein the waveguide has a circular cross section.

7. The electronic device of claim 6, wherein the horn has a conical shape.

8. The electronic device of claim 2, wherein the waveguide has a rectangular cross section.

9. The electronic device of claim 8, wherein the horn has a pyramidal shape.

10. The electronic device of claim 2, wherein the elongated portion extends along a first longitudinal axis and the horn extends along a second longitudinal axis that is non-parallel with respect to the first longitudinal axis.

11. The electronic device of claim 2, wherein the waveguide has an additional horn, the elongated portion being interposed between the horn and the additional horn.

12. The electronic device of claim 11, wherein the elongated portion extends along a first longitudinal axis, the horn extends along a second longitudinal axis that is non-parallel with respect to the first longitudinal axis, and the additional horn extends along a third longitudinal axis that is parallel to and laterally offset from the second longitudinal axis.

13. The electronic device of claim 1, wherein the electronic device comprises a dock device, the housing wall comprises a receiving surface configured to receive an external device, the receive port is configured to receive the second stream of wireless data from the external device through the housing wall and the waveguide, and the electronic device is configured to transmit the second stream of wireless data to a monitor.

14. An electronic device comprising:
an antenna;
a housing having a wall; and
a waveguide extending from a first surface facing the antenna to an opposing second surface facing the wall, wherein
the first surface has a first width,
the second surface has a second width greater than the first width, and
the antenna is configured to concurrently transmit and receive radio-frequency signals at a frequency through the waveguide and the wall.

15. The electronic device of claim 14, wherein the waveguide comprises:
a first portion extending from the first surface and having the first width; and
a second portion extending from the first portion to the second surface, the second portion having sidewalls oriented at a non-orthogonal angle with respect to the second end.

16. The electronic device of claim 15, wherein the first portion extends orthogonal to the first surface.

17. The electronic device of claim 15, wherein the first portion extends at a non-orthogonal angle with respect to the first surface.

18. The electronic device of claim 15, wherein the first surface extends parallel to the second surface, the first surface extends parallel to a plane of the antenna, the second surface extends parallel to the wall, the frequency is between 57 GHz and 64 GHZ, and the electronic device further comprises conductive traces that cover some but not all of the sidewalls of the second portion.

19. An electronic device configured to dock a first device to a second device, the electronic device comprising:
a transmit antenna configured to transmit first radio-frequency signals at a frequency;
a receive antenna configured to receive second radio-frequency signals at the frequency concurrent with transmission of the first radio-frequency signals by the transmit antenna;
a housing wall; and
a waveguide extending from a first end having a first width to an opposing second end having a second width greater than the first width, wherein
the first end faces and overlaps the transmit antenna and the receive antenna,
the waveguide has a first portion that extends from the first end, the first portion having the first width,
the waveguide has a second portion that extends from the first portion to the second end, the second portion having a width that increases from the first width at the first portion to the second width at the second end,
the waveguide is configured to convey the first radio-frequency signals from the transmit antenna through the housing wall, and
the waveguide is configured to convey the second radio-frequency signals from the housing wall to the receive antenna.

20. The electronic device of claim 19, wherein the first portion of the waveguide is linear and the second portion of the waveguide comprises a conical or pyramidal horn.
